(19) United States
(12) Patent Application Publication
(10) Pub. No.: US 2009/0250045 A1
(43) Pub. Date: Oct. 8, 2009

(54) Apparatus For Improving Vehicle Efficiency

(76) Inventor: Feng-Wen LIU, Nanxi Shiang (TW)

Correspondence Address: FRENKEL & ASSOCIATES, 3975 UNIVERSITY DR., STE. 330, FAIRFAX, VA, 22030, US

(21) Appl. No.: 12/060,919

(22) Filed: Apr. 2, 2008

(51) Int. Cl. F02B 23/00

(52) U.S. Cl. 123/585

(57) ABSTRACT

An apparatus for improving vehicle efficiency mainly includes a vehicle engine and an oxygen producing device. The oxygen producing device is located on an intake passage between an air filter and an intake manifold to increase oxygen content in the air. When the air enters the air intake passage and passes through the air filter, the air and pure oxygen are drawn into the engine through the intake manifold. Hence combustion in the engine is proceeded more efficiently due to increase of oxygen content. And the engine has a higher transformation effect to boost horsepower. Fuel-saving effect of the engine also improves. And exhaust gas can be discharged more eco-friendly to reduce air pollution.

### FIELD OF THE INVENTION

The present invention relates to an apparatus for improving vehicle efficiency and particularly to an apparatus to improve combustion of a vehicle engine to generate horsepower and reduce fuel consumption and make discharged exhaust gas more eco-friendly to reduce air pollution.

### BACKGROUND OF THE INVENTION

Conventional approaches to improve vehicle power mostly involve a great deal of work to modify engines, such as enlarging the cylinders, deploying a high capacity air filter and the like to boost displacement. Some other approaches include adding an external turbine, boosting pressure mechanically or the like aim to get forced air intake.

All those approaches have drawbacks in practices, notably:

1. To enlarge the cylinders, the cylinders have to be replaced, and many other associated components such as cylinder jackets, pistons, cranks, linkage bars and the like also have to be replaced to match the greater cylinder diameter. Not only the cost increases, because the driving system generates greater power, the capacity of the radiator could be not sufficient to disperse heat being generated. As a result the temperature of the vehicle is higher.

2. Although the external turbine can enhance the torque at high speed, the torque at low speed suffers. Hence a sluggish phenomenon occurs. This results in unsmooth driving on a winding mountain road or shorter straight road.

### SUMMARY OF THE INVENTION

The present invention aims to provide an apparatus to improve vehicle efficiency to overcome the aforesaid problems occurred to the conventional techniques to boost the horsepower of a vehicle without changing the vehicle and improve fuel-saving of the engine.

To achieve the foregoing object, the apparatus according to the invention mainly includes a vehicle engine and an oxygen producing device. The engine has an intake manifold at one side which in turn has an air intake passage at another side thereof to receive air and pure oxygen. There is an air filter connecting to another side of the air passage. The oxygen producing device is located between the air filter and the intake manifold to increase oxygen content in the air. When the air enters the air intake passage and passes through the air filter, through the action of stepping the accelerator of the driver, air and pure oxygen are drawn into the engine through the intake manifold. Hence combustion in the engine is proceeded more efficiently due to increasing of oxygen content. And the engine can have a higher transformation effect to boost the horsepower. Moreover, due to more efficient combustion the exhaust gas being discharged is more eco-friendly, and air pollution can be reduced and more dynamic power can be generated. As a result the horsepower increases without changing fuel supply of the vehicle and fuel-saving effect of the engine also improves.

In addition, the oxygen producing device of the invention may also be installed on a connection tube bridging an exhaust gas recycling system and the intake manifold. A portion of the exhaust gas is discharged through an exhaust pipe, while other portion of the exhaust gas enters the exhaust gas recycling system. Thus when the accelerator is stepped, the exhaust gas, air and pure oxygen enter the engine through the intake manifold. Combustion in the engine is proceeded more efficiently due to increasing of the oxygen content. As a result, the engine has a higher transformation effect to boost the horsepower, and the exhaust gas being discharged is more eco-friendly, and air pollution can be reduced

The foregoing, as well as additional objects, features and advantages of the invention will be more readily apparent from the following detailed description, which proceeds with reference to the accompanying drawings. The embodiments discussed below serve only for illustrative purpose, and are not the limitation of the invention.

### BRIEF DESCRIPTION OF THE DRAWINGS

FIG. 1 is a schematic view of an embodiment of the apparatus of the invention.

FIG. 2 is a schematic view of another embodiment of the apparatus of the invention.

FIG. 3 is a schematic view of yet another embodiment of the apparatus of the invention.

### DETAILED DESCRIPTION OF THE PREFERRED EMBODIMENTS

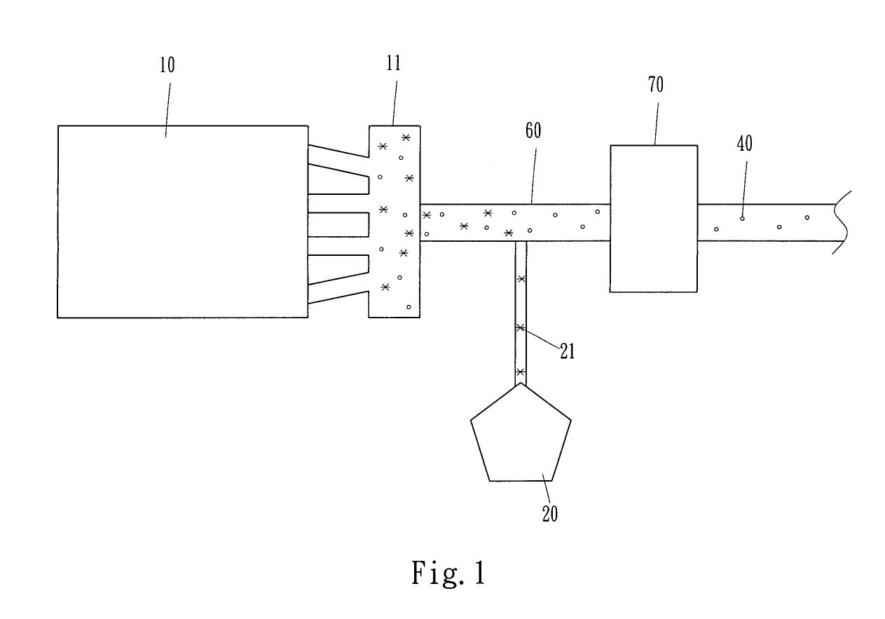

Please refer to FIG. 1, the apparatus for improving vehicle efficiency according to the invention mainly includes a vehicle engine 10 and an oxygen producing device 20. The engine 10 has an intake manifold 11 at one side which in turn has an air intake passage 60 at another side thereof to receive air 40 and pure oxygen 21. There is an air filter 70 connecting to another side of the air passage 60. The oxygen producing device 20 is located on the air passage 60 between the air filter 70 and the intake manifold 11 to increase oxygen content in the air 40. When the air 40 enters the air intake passage 60 and passes through the air filter 70, through the action of stepping the accelerator of the driver, the air 40 and pure oxygen 21 are drawn into the engine 10 through the intake manifold 11. Hence combustion in the engine 10 is proceeded more efficiently due to increase of oxygen content. And the engine has a higher transformation effect to boost horsepower. Moreover, due to more efficient combustion, exhaust gas 31 being discharged is more eco-friendly, and air pollution can be reduced and more dynamic power can be generated. As a result the horsepower increases without changing the original fuel supply setting of the vehicle, and fuel-saving effect of the engine 10 also improves.

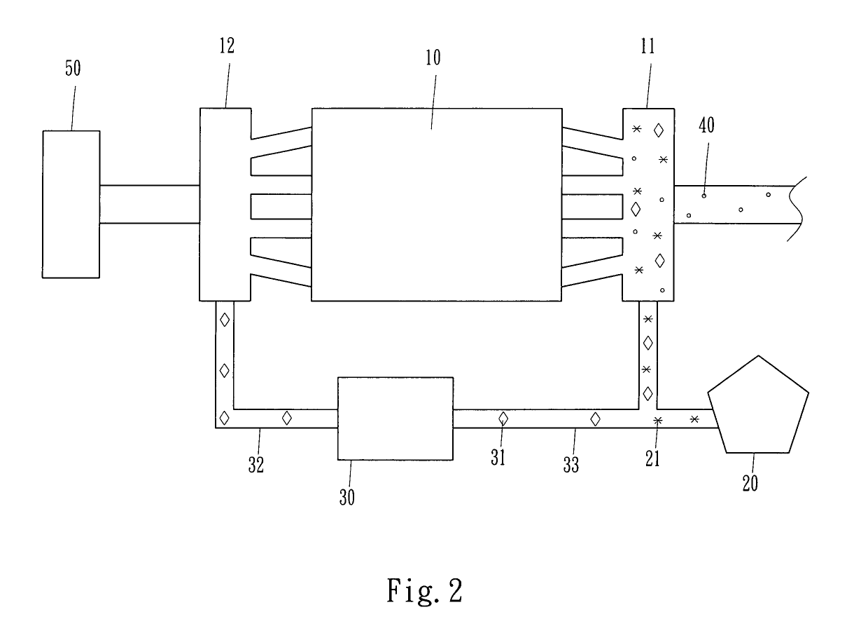

In addition, the oxygen producing device 20 of the invention may also be installed on a connection tube 33 bridging an exhaust gas recycling system 30 and the intake manifold 11 as shown in FIG. 2. There is an exhaust manifold 12 at one side of the engine 10 opposite to the intake manifold 11 at another side. The exhaust manifold 12 aims to discharge the exhaust gas 31 from the engine 10 after combustion. There is an exhaust pipe 50 at one side of the exhaust manifold 12 to discharge the exhaust gas 31 and a passage 32 at another side to channel a portion of the exhaust gas 31 to the exhaust gas recycling system 30. The connection tube 33 is located at another side of the exhaust gas recycling system 30 to connect the oxygen producing device 20 and the intake manifold 11. The oxygen producing device 20 regulates flow amount of the pure oxygen 21 to match the engine 20. It aims to boost the oxygen content in the recycled exhaust gas 31. After the exhaust gas 31 has entered the exhaust manifold 12, a portion of the exhaust gas 31 is discharged through the exhaust pipe 50, while other portion of the exhaust gas 31 enters the exhaust gas recycling system 30. Thus when the accelerator is stepped, the exhaust gas 31 and pure oxygen 21 are channeled into the intake manifold 11 through the connection tube 33 so that the exhaust gas, air 40 and pure oxygen 21 enter the engine 10 through the intake manifold 11. Combustion in the engine 10 is proceeded more efficiently due to increase of the oxygen content. As a result, the engine 10 has a higher transformation effect to boost the horsepower, and the exhaust gas 31 being discharged is more eco-friendly, and air pollution of the air 40 is reduced.

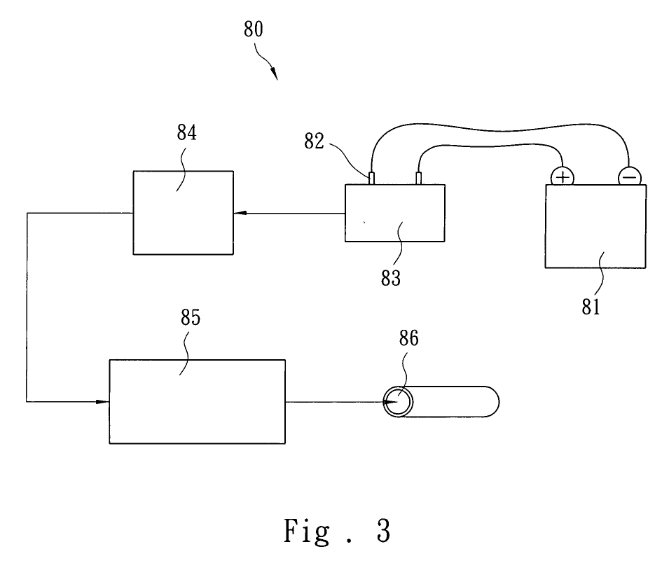

The oxygen producing device 20 may be a filling oxygen tank. The oxygen producing device 20 includes an oxygen generating apparatus 80 located in the engine 10 (referring to FIG. 3) that has one side electrically connected to a DC and AC converter 81 and 82. The AC converter 82 has a voltage rectifier 83 transferred to an air compressor 84. The air in the air compressor 84 is transferred to an oxygen molecular sieve assembly 85 which conveys pure oxygen into the engine 10 through an air inlet 86, so that oxygen content in the engine 10 is enriched and combustion in the engine 10 improves. As a result, the engine 10 has a higher transformation performance and horsepower increases.

As a conclusion, the apparatus for improving vehicle efficiency of the invention mainly provides the following features:

1. Because of the apparatus oxygen content in the air 40 increases, hence combustion is proceeded more efficiently. As a result, transformation of the engine 10 improves, and the horsepower of the engine 10 can be boosted.

2. As the engine 10 according to the invention can achieve more efficient combustion, the horsepower can be boosted without changing the original setting of the fuel supply system. Thus fuel consumption is reduced and fuel-saving effect can be achieved.

What is claimed is:

1. An apparatus for improving vehicle efficiency, comprising:
an engine having an intake manifold at one side which has an air intake passage at another side thereof to receive air and pure oxygen, the air passage having other side connecting to an air filter; and
an oxygen producing device which is located between the air filter and the intake manifold to increase oxygen content in the air.

2. The apparatus of claim 1, wherein the oxygen producing device is installed on a connection tube bridging an exhaust gas recycling system and the intake manifold.

3. The apparatus of claim 1, wherein the oxygen producing device is an oxygen producing equipment.

4. The apparatus of claim 1, wherein the oxygen producing device is a filling oxygen tank.
